(19) United States
(12) Patent Application Publication
(10) Pub. No.: US 2020/0292129 A1
(43) Pub. Date: Sep. 17, 2020

(54) CNG Storage Tank System with Secondary Containment and Monitoring

(71) Applicant: R. Keith Barker, Walhalla, SC (US)

(72) Inventor: R. Keith Barker, Walhalla, SC (US)

(21) Appl. No.: 16/820,088

(22) Filed: Mar. 16, 2020

Related U.S. Application Data
(60) Provisional application No. 62/818,219, filed on Mar. 14, 2019.

(51) Int. Cl. F17C 1/16; F17C 13/04; F17C 13/06; F17C 13/02

(52) U.S. Cl. CPC F17C 1/16; F17C 13/04; F17C 13/06; F17C 13/028; F17C 2201/0104; F17C 2203/0673; F17C 2205/0149; F17C 2250/0426; F17C 2250/0478; F17C 2221/033; F17C 2205/0134; F17C 2205/0176; F17C 2205/0326; F17C 2203/066

(57) ABSTRACT

A CNG storage tank system with secondary containment and monitoring, such that any leaks from a primary containment tank are initially contained within a secondary containment tank, detected by a CNG sensing system in communication with a monitoring station, such that leaked CNG in the form of methane can be safely and controllably vented to the atmosphere or into CNG capture tanks. In addition, a tank expansion detection system may be employed to detect excessive expansion of the primary containment tank.

### BACKGROUND OF THE INVENTION

This invention relates generally to the field of receiving, storing and dispensing compressed natural gas (CNG), and more particularly relates to the field of CNG storage tanks, both stationary tanks, above or below ground, and tanks used in transport by trucks, railcars or the like.

Compressed natural gas is essentially purified methane gas stored at high pressure in tanks capable of sustaining 5000 psi or greater. CNG is a cleaner and cheaper alternative to gasoline or diesel fuel for powering motor vehicles and the like. The natural gas is compressed to less than 1% of its normal volume when at standard atmospheric pressure.

Buried CNG storage tanks and to a lesser extent above ground storage or transport tanks can suffer degradation over time, such that leaks may develop in the tanks. For example, buried tanks made of fiber reinforced polymers (FRP) are subject to chemical or reactive ground elements as well as compression hoop stress with wall movement (expansion and contraction) which accelerates the decomposition of the glass strand and resin bond, thus reducing tank life.

It is important to design tanks that are both resistant to such degradation, are able to contain leaked CNG within a secondary containment tanks, are able to safely release leaked gas to avoid catastrophic failure or explosive situations due to gas pocketing or excessive venting to atmosphere, and which may be monitored to ascertain leaks when they first occur. While visual inspections are useful for above ground tanks, this is not possible for buried tanks. For on-site storage, buried tanks are most preferable as there is no concern for setback regulations and nearby powerlines, roads or sidewalks, and further burial of the tanks increases the amount of space available for above ground structures and equipment. Thus, it is an object of this invention to provide CNG storage tanks that address these problems by providing CNG tank constructions with venting, secondary containment and monitoring systems.

### SUMMARY OF THE INVENTION

In general, the invention is in various embodiments is a CNG storage tank system with secondary containment and monitoring, such that any leaks from a primary containment tank are initially contained within a secondary containment tank, detected by a CNG sensing system in communication with a monitoring station, such that leaked CNG in the form of methane can be safely and controllably vented to the atmosphere or into CNG capture tanks. In addition, a tank expansion detection system may be employed to detect excessive expansion of the primary containment tank. The CNG storage system includes buried tanks, above ground tanks and tanks used to transport of CNG. The system enables the monitoring of inground CNG storage tanks which are not able to be inspected visually. The monitoring station may be local or remote, and multiple monitoring stations may be utilized. In the primary embodiment the primary containment tank, structured to withstand the high pressure necessary for CNG, is positioned within the secondary containment tank, which is composed of CNG impermeable material able to protect the primary containment tank from environmental damage, such as physical force effects, fire, degradative ground elements, acids, pollution, water, etc. The primary containment tank is separated from the secondary containment tank by an interstitial spacing member that is chosen or constructed so as not to impede gas flow within the interstitial gap created by the interstitial spacing member.

In alternative summary, the invention in various embodiments is a CNG storage tank system comprising: a primary containment tank characterized in that the primary containment tank is structured to withstand an internal pressure sufficient to retain CNG; a secondary containment tank characterized in that the secondary containment tank is impermeable to CNG; an interstitial spacing member disposed between the primary containment tank and the secondary containment tank such that an interstitial gap is present between the primary containment tank and the secondary containment tank, wherein the interstitial spacing member allows CNG to flow within the interstitial gap; a CNG sensing system in communication with the interstitial gap wherein the presence of CNG in the interstitial gap is sensed by the CNG sensing system; and a monitoring station in communication with the CNG sensing system, the monitoring system activating operational components of the CNG sensing system and/or alerting personnel when the CNG sensing system indicates the presence of CNG within the interstitial gap. Furthermore, such system further comprising a tank expansion detection system in communication with the monitoring station wherein expansion of the primary containment tank is sensed by the tank expansion detection system and communicated to the monitoring station; wherein the primary containment tank is positioned within the secondary containment tank; wherein the CNG sensing system comprises: CNG detection sensors; a venting conduit in communication with the interstitial gap such that CNG present in the interstitial gap may be released into the atmosphere or into a CNG capture tank; and a communication system transmitting CNG information to the monitoring station; wherein the CNG sensing system further comprises a static mixing valve and a venturi tube such that prior to release of CNG into the atmosphere a mixture of CNG and air is produced wherein the CNG (methane) content of the mixture is at least 15 vol. %; wherein the tank expansion detection system comprises: one or more encircling strain gauge members positioned about the primary containment tank; a communication system transmitting tank expansion information to the monitoring station; and a strain gauge sensor in communication with the one or more strain gauge members and the communication system; wherein the primary containment tank is composed of fiber reinforced polymer and the secondary containment tank is composed of HDPE; wherein the interstitial spacing member is composed of a perforated, apertured, channeled or CNG permeable member; the CNG sensing system further comprising a secondary containment end cap, wherein CNG present in the interstitial gap passes through the secondary containment end cap; wherein the secondary containment tank is positioned within the primary containment tank; and/or wherein the secondary containment tank is positioned within the primary containment tank.

### BRIEF DESCRIPTION OF THE DRAWINGS

FIG. 1 is an illustration of a first embodiment of the CNG storage tank system showing the secondary containment tank external to the primary containment tank.

FIG. 2 is a cross-sectional view taken along line 2-2 of FIG. 1.

FIG. 3 is an illustration of a second embodiment of the CNG storage tank system showing the primary containment tank external to the secondary containment tank.

FIG. 4 is a cross-sectional view taken along line 4-4 of FIG. 2.

### DETAILED DESCRIPTION OF THE INVENTION

In general, the invention is in various embodiments is a CNG storage tank system with secondary containment and monitoring, such that any leaks from a primary containment tank 11 are initially contained within a secondary containment tank 12, detected by a CNG sensing system 20 in communication with a monitoring station 90, such that leaked CNG in the form of methane can be safely and controllably vented to the atmosphere or into CNG capture tanks. In addition, a tank expansion detection system 30 may be employed to detect excessive expansion of the primary containment tank 11. The CNG storage system includes buried tanks, above ground tanks and tanks used to transport of CNG. The system enables the monitoring of inground CNG storage tanks which are not able to be inspected visually. The monitoring station 90 may be local or remote, and multiple monitoring stations 90 may be utilized. In the primary embodiment the primary containment tank 11, structured to withstand the high pressure necessary for CNG, is positioned within the secondary containment tank 12, which is composed of CNG impermeable material able to protect the primary containment tank from environmental damage, such as degradative ground elements, acids, pollution, water, etc. The primary containment tank 11 is separated from the secondary containment tank 12 by an interstitial spacing member 13 that is chosen or constructed so as not to impede gas flow within the interstitial gap 18 created by the interstitial spacing member 13. As with typical CNG storage tanks, an outlet boss connector 14 and outflow conduit 15 are provided for delivery of the CNG as needed. A vent outlet 17 is also present for release of the leaked CNG to atmosphere to delivery into a CNG capture tank under controlled conditions.

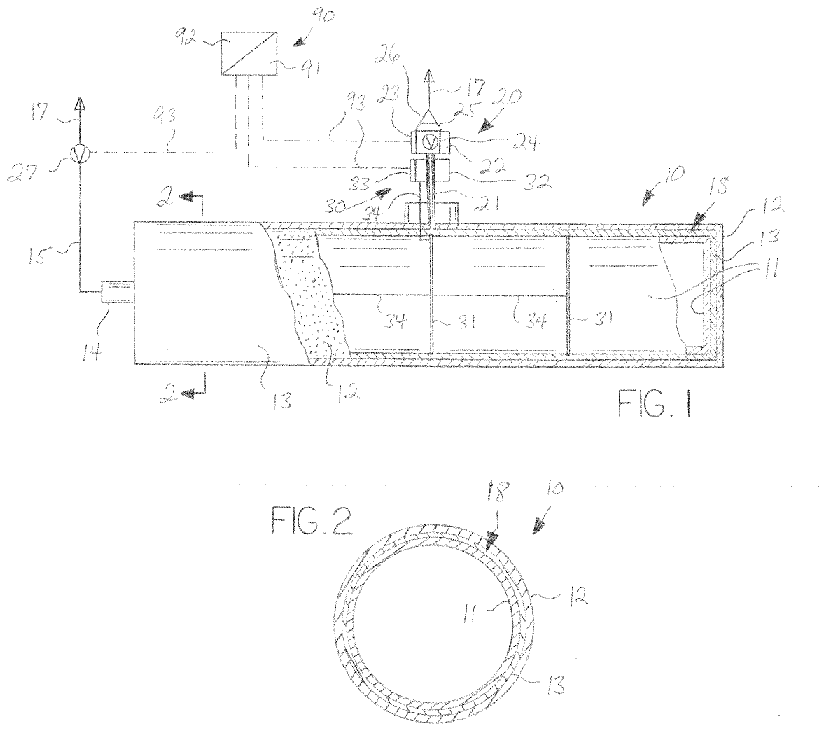

With reference to FIGS. 1 and 2, a primary embodiment of the CNG storage tank system is shown to comprise a CNG tank assembly 10 comprising a primary containment tank 11, a secondary containment tank 12 and an interstitial spacer member 13. The primary containment tank 11 is constructed to withstand the high internal pressure required to retain CNG, preferably the primary containment tank 11 is able to withstand greater than 5000 psi. The primary containment tank 11 may be composed of various materials, but is preferably comprises a fiber reinforced polymer (FRP), such as are often referred to as FRP winding tanks. The primary containment tank 11 provides the structural integrity for the CNG tank assembly 10.

The primary containment tank 11 is positioned within a secondary containment tank 12. The secondary containment tank 12 is composed of a material that is impermeable to CNG, or more particularly to CNG leaked from the primary containment tank 11, which because of the reduction in pressure is essentially methane gas. The secondary containment tank 12 may be composed of high density polyethylene (HDPE), which is easily disposed about the primary containment tank 11 during manufacture of the CNG storage tank system 10, such as by fusion welding HDPE segments or panels. In addition to being impermeable to CNG, the material chosen for the secondary containment tank 12 is preferably material that also protects the primary containment tank 11 from damage or degradation caused by physical force effects, fire, ground elements, acids, pollution, water, etc. which would be encountered in inground installations.

An interstitial spacing member 13 is disposed between primary containment tank 11 and the secondary containment tank 12 to create an interstitial gap 18. The material of composition or the structure of the interstitial spacing member 13 is chosen such that leaked CNG (methane) can flow through the interstitial gap 18 for detection and release. For example, the interstitial spacing member 13 may be apertured, perforated, gas permeable or channeled, and may consist of a geogrid plastic liner, perforated double-wall metal sheets, expanded metal webbing, or the like. The interstitial gap 18 communicates with a vent outlet 17 which enables controlled release of leaked CNG into the atmosphere or into a CNG capture tank (not shown).

The CNG storage tank system further comprises a CNG sensing system 20 which detects the presence of leaked CNG within the interstitial gap 18. The CNG sensing system 20 preferably comprises a venting conduit 21 in communication with the interstitial gap 18 and the vent outlet 17, CNG detection sensors 22 for detecting the presence of leaked CNG within the interstitial gap 18 or the venting conduit 21, a CNG communication system 23 for transmitting over communication channels 93 CNG information to a monitoring station 90 and for receiving operational instructions from the monitoring station 90 to control a valve 24 for release of leaked CNG. Because the leaked CNG, i.e., methane gas, is highly explosive unless a suitable amount of air is present (less than 5 vol. % or more than 85 vol. %), most preferably the CNG sensing system 20 is able to measure the vol. % of the CNG and comprises a static mixing valve 25 and venturi tube 26 upstream from the vent outlet 17 which insures that sufficient air is added to the leaked CNG as needed to provide a mixture wherein the CNG (methane gas) is more than 15 vol. % of the mixture.

In a more preferred embodiment, the CNG storage tank system further comprises a tank expansion detection system 30 which monitors physical changes in the primary containment tank 11, for example, expansion of the cylindrical wall of the primary containment tank 11 due to faulty materials, manufacture, damage or degradation. The tank expansion detection system 30 preferably comprises one or more encircling strain gauge members 31, a strain gauge sensor 32, wiring 34 connecting the plural strain gauge members 31 to the strain gauge sensor 32 and to a strain gauge communication system 33 transmitting information to a monitoring station 90. The strain gauge members 31 may comprise for example low voltage, DC powered, millivolt wires that will not arc.

The monitoring station 90 receiving and transmitting information and commands from and to the CNG communication system 23 and the strain gauge communication system 33 may be an onsite or local station may be a geographically remote station. The monitoring station 90 may communicate instructions or commands to onsite personnel to address a leaking CNG problem or may directly initiate responsive action or actions to be undertaken by the CNG storage tank system 10, such as opening valve 24 to vent leaked CNG to the atmosphere or initiating the static mixing valve 25 to add air to the leaked CNG prior to release. The monitoring station 90 may also activate an emergency relief valve 27 if rapid release is required to avoid an explosion. Alternatively, the relief valve 27 may be pressure actuated such that excessively high pressure will automatically open the relief valve 27. The monitoring station 90 may involve or communicate to one or more response entities, such as an equipment monitoring company 91 and/or a fire and safety monitoring company 92, either of which can contact and direct appropriate personnel if needed onsite.

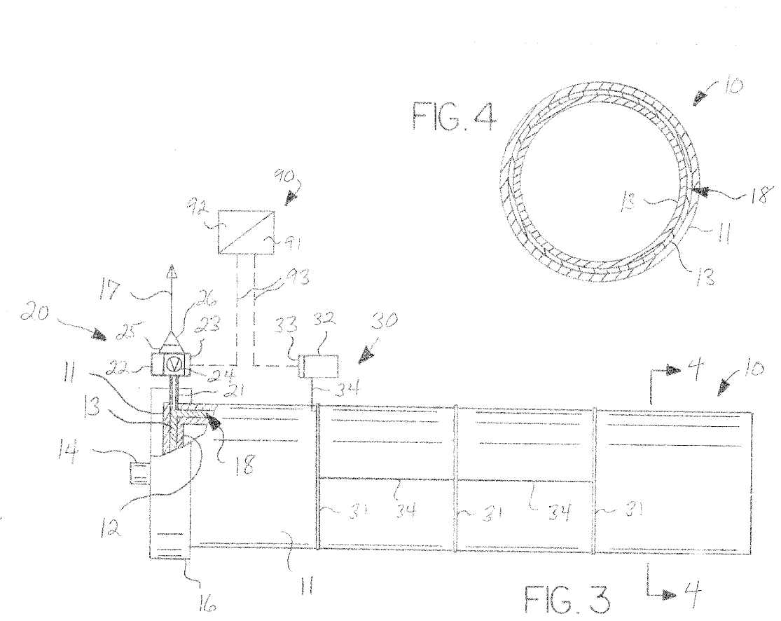

In an alternate embodiment illustrated in FIGS. 3 and 4, the CNG tank assembly 10 comprises a secondary containment tank 12 is positioned internally to the primary containment tank 11, such that in combination with the interstitial spacing member 13 an interstitial gap 18 is created. Such a combination may be suitable for storage tanks used in transportation or above-ground where protection of the primary containment tank 11 from environmental damage is not required. As illustrated, secondary containment end cap 16 may be positioned on the end of the CNG tank assembly 10, with the CNG sensing system 20 communicating through the end cap 16.

It is understood that equivalents and substitutions for certain elements set forth above may be obvious to those of ordinary skill in the art, and therefore the true scope and definition of the invention is to be as set forth in the following claims. The illustrations and examples above are not intended to be limiting.

1. A CNG storage tank system comprising:
a primary containment tank characterized in that the primary containment tank is structured to withstand an internal pressure sufficient to retain CNG;
a secondary containment tank characterized in that the secondary containment tank is impermeable to CNG;
an interstitial spacing member disposed between the primary containment tank and the secondary containment tank such that an interstitial gap is present between the primary containment tank and the secondary containment tank, wherein the interstitial spacing member allows CNG to flow within the interstitial gap;
a CNG sensing system in communication with the interstitial gap wherein the presence of CNG in the interstitial gap is sensed by the CNG sensing system; and
a monitoring station in communication with the CNG sensing system, the monitoring system activating operational components of the CNG sensing system and/or alerting personnel when the CNG sensing system indicates the presence of CNG within the interstitial gap.

2. The CNG storage tank system of claim 1, further comprising a tank expansion detection system in communication with the monitoring station wherein expansion of the primary containment tank is sensed by the tank expansion detection system and communicated to the monitoring station.

3. The CNG storage tank system of claim 1, wherein the primary containment tank is positioned within the secondary containment tank.

4. The CNG storage tank system of claim 2, wherein the primary containment tank is positioned within the secondary containment tank.

5. The CNG storage tank system of claim 1, wherein the CNG sensing system comprises:
CNG detection sensors;
a venting conduit in communication with the interstitial gap such that CNG present in the interstitial gap may be released into the atmosphere or into a CNG capture tank; and
a communication system transmitting CNG information to the monitoring station.

6. The CNG storage tank system of claim 2, wherein the CNG sensing system comprises:
CNG detection sensors;
a venting conduit in communication with the interstitial gap such that CNG present in the interstitial gap may be released into the atmosphere or into a CNG capture tank; and
a communication system transmitting CNG information to the monitoring station.

7. The CNG storage tank system of claim 3, wherein the CNG sensing system comprises:
CNG detection sensors;
a venting conduit in communication with the interstitial gap such that CNG present in the interstitial gap may be released into the atmosphere or into a CNG capture tank; and
a communication system transmitting CNG information to the monitoring station.

8. The CNG storage tank system of claim 5, wherein the CNG sensing system further comprises a static mixing valve and a venturi tube such that prior to release of CNG into the atmosphere a mixture of CNG and air is produced wherein the CNG content of the mixture is at least 15 vol. %.

9. The CNG storage tank system of claim 6, wherein the CNG sensing system further comprises a static mixing valve and a venturi tube such that prior to release of CNG into the atmosphere a mixture of CNG and air is produced wherein the CNG content of the mixture is at least 15 vol. %.

10. The CNG storage tank system of claim 7, wherein the CNG sensing system further comprises a static mixing valve and a venturi tube such that prior to release of CNG into the atmosphere a mixture of CNG and air is produced wherein the CNG content of the mixture is at least 15 vol. %.

11. The CNG storage tank system of claim 2, wherein the tank expansion detection system comprises:
one or more encircling strain gauge members positioned about the primary containment tank;
a communication system transmitting tank expansion information to the monitoring station; and
a strain gauge sensor in communication with the one or more strain gauge members and the communication system.

12. The CNG storage tank system of claim 4, wherein the tank expansion detection system comprises:
one or more encircling strain gauge members positioned about the primary containment tank;
a communication system transmitting tank expansion information to the monitoring station; and
a strain gauge sensor in communication with the one or more strain gauge members and the communication system.

13. The CNG storage tank system of claim 1, wherein the primary containment tank is composed of fiber reinforced polymer and the secondary containment tank is composed of HDPE.

14. The CNG storage tank system of claim 2, wherein the primary containment tank is composed of fiber reinforced polymer and the secondary containment tank is composed of HDPE.

15. The CNG storage tank system of claim 1, wherein the interstitial spacing member is composed of a perforated, apertured, channeled or CNG permeable member.

16. The CNG storage tank system of claim 2, wherein the interstitial spacing member is composed of a perforated, apertured, channeled or CNG permeable member.

17. The CNG storage tank system of claim 5, the CNG sensing system further comprising a secondary containment end cap, wherein CNG present in the interstitial gap passes through the secondary containment end cap.

18. The CNG storage tank system of claim 6, the CNG sensing system further comprising a secondary containment end cap, wherein CNG present in the interstitial gap passes through the secondary containment end cap.

19. The CNG storage tank system of claim 17, wherein the secondary containment tank is positioned within the primary containment tank.

20. The CNG storage tank system of claim 18, wherein the secondary containment tank is positioned within the primary containment tank.
